(19) United States
(12) Patent Application Publication
(10) Pub. No.: US 2008/0263595 A1
(43) Pub. Date: Oct. 23, 2008

(54) Information processing apparatus and method and program

(75) Inventors: Kazuhito Sumiyoshi, Tokyo (JP); Koji Matsuura, Tokyo (JP); Hideki Asazu, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/082,924

(22) Filed: Apr. 15, 2008

(30) Foreign Application Priority Data
Apr. 18, 2007 (JP) P2007-109457

(51) Int. Cl. H04N 7/10

(52) U.S. Cl. 725/39

(57) ABSTRACT

In the present invention, there is provide an information processing apparatus configured to present, to a user, a content guide arranged with a plurality of content frames including information for guiding predetermined content, the information processing apparatus including: a presentation control unit for presenting, to the user, if a first content guide of a first range is being presented, a second content guide formed by a second range different from the first range when a first condition is satisfied, the second content guide including a focus content frame focused as processing subject when the first condition was satisfied, instead of the first content guide.

### CROSS REFERENCES TO RELATED APPLICATIONS

The present invention contains subject matter related to Japanese Patent Application JP 2007-109457 filed in the Japan Patent Office on Apr. 18, 2007, the entire contents of which being incorporated herein by reference.

### BACKGROUND OF THE INVENTION

1. Field of the Invention

The present invention relates to an information processing apparatus and method and a program and, more particularly, to an information processing apparatus and method and a program that are configured to allow users to easily and quickly find desired pieces of content from a content list.

2. Description of the Related Art

Recently, information processing apparatuses (as disclosed in Japanese Patent Laid-Open No. Hei 9-9193, Japanese Patent Laid-Open No. 2001-313878, and Japanese Patent Laid-Open No. 2001-8122) on which EPGs (Electronic Program Guides) can be displayed have been gaining popularity. By means of these EPGs, user can find desired broadcast programs to be viewed and recorded, for example.

### SUMMARY OF THE INVENTION

However, in the recent highly information-oriented society, there is a trend that the number of broadcast programs that are handled by EPGs has been remarkably increasing as compared with the past. As a result, it takes much more time and labor for users to find desired broadcast programs than before. This trend seems to continue in the future.

The above-mentioned situation is also found in operations, such as finding out desired particular items of content from among a lot of items of content distributed via not only television broadcasting, but also networks, such as the Internet, and using content lists of these items of content.

Therefore, the present invention addresses the above-identified and other problems associated with related-art methods and apparatuses and solves the addressed problems by providing an information processing apparatus and method and a computer program that are configured to support users to easily and quickly find desired items of content from a content list.

In carrying out the invention and according to a first embodiment thereof, there is provided an information processing apparatus configured to present, to a user, a content guide arranged with a plurality of content frames including information for guiding predetermined content. This information processing apparatus has a presentation control unit for presenting, to the user, if a first content guide of a first range is being presented, a second content guide formed by a second range different from the first range when a first condition is satisfied, the second content guide including a focus content frame focused as processing subject when the first condition was satisfied, instead of the first content guide.

In the above-mentioned information processing apparatus, if the second content guide is being presented, the presentation control unit presents the first content guide instead of the second content guide if a second condition is satisfied.

The above-mentioned information processing apparatus further has an operator unit through which the user moves the focus content frame, wherein if the focus content frame has moved outside the first range by an operation by the user through the operator unit with the first content guide presented, the presentation control unit determines that the first condition has been satisfied, thereby presenting, to the user, the second content guide formed by the second range including at least the first range and, if the focus content frame has moved into the first range by an operation done by the user through the operator unit with the second content guide presented, the presentation control unit presents, to the user, the first content guide.

In the above-mentioned information processing apparatus, if the first content guide is presented, the presentation control unit presents, to the user, the second content guide when a status in which the user uses predetermined content is switched from a first status to a second status and, if the second content guide is presented, the presentation control unit presents, to the user, the first content guide when the status in which the user uses predetermined content is switched from the second status to the first status.

An information processing method and a program according to other embodiments of the invention are a method and a program corresponding to the above-mentioned information processing apparatus according to the first embodiment of the invention.

In the information processing apparatus, the information processing method, and the program according to various embodiments of the invention, a content guide arranged with a plurality of content frames including information for guiding predetermined content is presented to the user as follows. Namely, if the first condition is satisfied with the first content guide of the first range presented, the second content guide formed by the second range different from the first range, said second content guide including a focus content frame focused as processing subject when the first condition was satisfied, is presented to the user instead of the first content guide.

As described and according to the invention, a content guide that is a table of content can be presented to the user. Especially, use of the content guide thus presented allows the user to find desired content more easily and quickly than related-art technologies.

### BRIEF DESCRIPTION OF THE DRAWINGS

FIG. 1 is a diagram illustrating an outline of a GUI (Graphical User Interface) display technique according to embodiments of the invention;

FIG. 2 is a diagram illustrating an outline of the above-mentioned GUI display technique practiced as one embodiment of the invention;

FIG. 3 is a flowchart indicative of one example of program guide switching processing in the above-mentioned first embodiment;

FIG. 4 is a diagram illustrating a specific processing result of the program guide switching processing shown in FIG. 3;

FIG. 5 is a diagram illustrating another specific processing result of the program guide switching processing shown in FIG. 3;

FIG. 6 is a diagram illustrating still another specific processing result of the program guide switching processing shown in FIG. 3;

FIG. 7 is a diagram illustrating a variation to the first embodiment;

FIG. 8 is a diagram illustrating another variation to the first embodiment;

FIG. 9 is a diagram illustrating a GUI display technique practiced as a second embodiment of the invention;

FIG. 10 is a flowchart indicative of an example of program guide switching processing in the second embodiment;

FIG. 11 is a flowchart indicative of another example of the program guide switching processing in the second embodiment;

FIG. 12 is a functional block diagram illustrating an exemplary functional configuration of an information processing apparatus to which the present invention is applied; and

FIG. 13 is a block diagram illustrating an exemplary configuration of a computer practiced as another embodiment of an information processing apparatus to which the present invention is applied.

### DETAILED DESCRIPTION OF THE PREFERRED EMBODIMENTS

This invention will be described in further detail by way of embodiments thereof with reference to the accompanying drawings. This invention will be described in further detail by way of example with reference to the accompanying drawings. The invention described herein and the embodiments thereof have the following correlation. The description hereof is intended to make sure of the fact that the embodiments supporting the invention described herein are described herein. Therefore, if there is any embodiment that, although described in the description of the preferred embodiment, is not described herein as corresponding to the invention, this does not denote in any manner that such an embodiment does not correspond to the present invention. Conversely, if any embodiment is described herein as corresponding to the invention, it does not denote in any manner that such an embodiment does not correspond to other inventions than the present invention.

Further, the description hereof does not denote the entire invention described herein. In other words, the existence of any invention described herein and not claimed herein will not deny the existence of any inventions that may be filed as a divisional application, emerge as a result of amendment, or added hereto in the future.

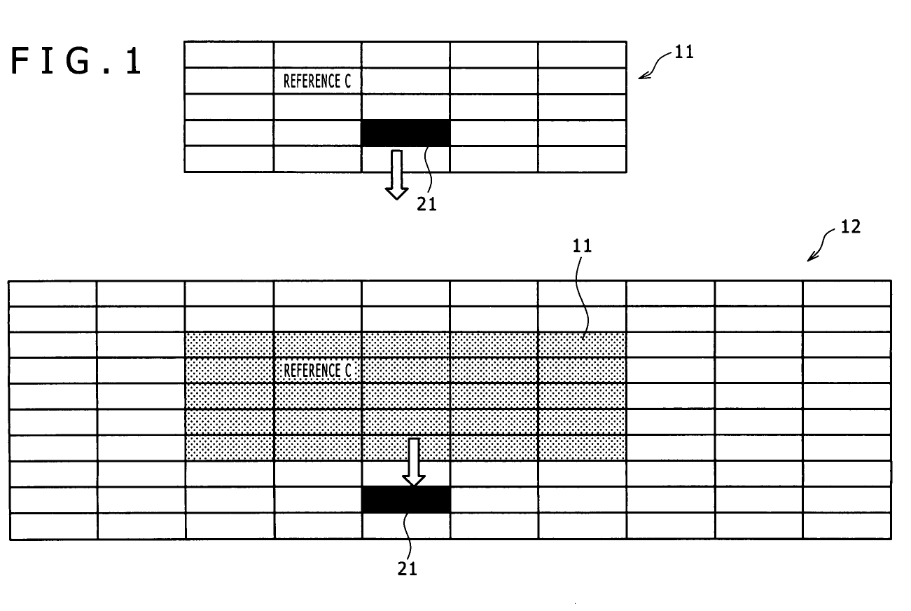

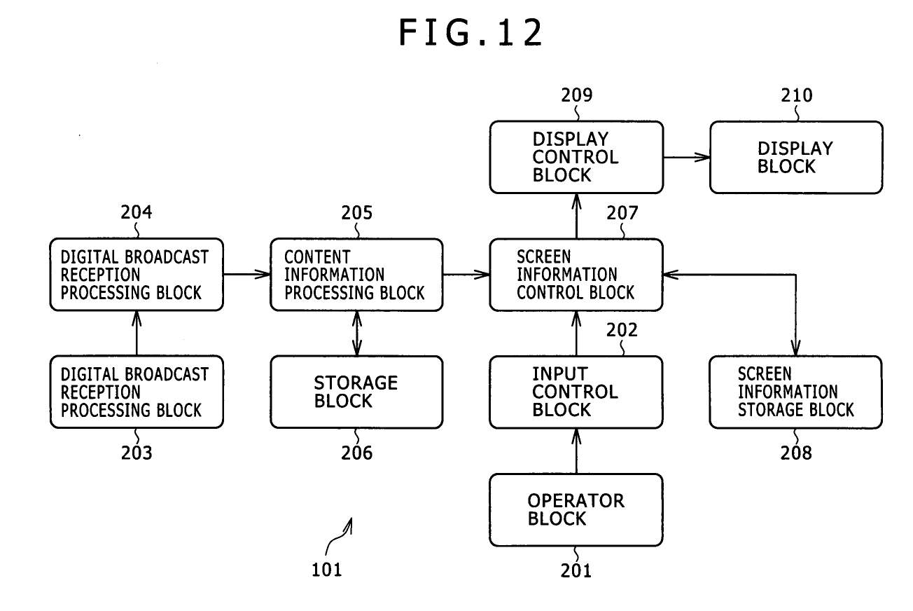

An information processing apparatus according to an embodiment of the invention (for example, an information processing apparatus 101 shown in FIG. 12) is configured to present, to a user, a content guide arranged with a plurality of content frames including information for guiding predetermined content. This information processing apparatus has a presentation control unit (for example, a screen information control block 207 or a display control block 209 shown in FIG. 12) for presenting, to the user, if a first content guide (for example, a main content guide 11 shown in FIG. 1) of a first range is being presented, a second content guide (for example, am associated content guide 12 shown in FIG. 1) formed by a second range different from the first range when a first condition is satisfied, the second content guide including a focus content frame (for example, a content frame arranged with a focus 21 shown in FIG. 1) focused as processing subject when the first condition was satisfied, instead of the first content guide.

In the above-mentioned information processing apparatus, if the second content guide is being presented, the presentation control unit presents the first content guide instead of the second content guide if a second condition is satisfied.

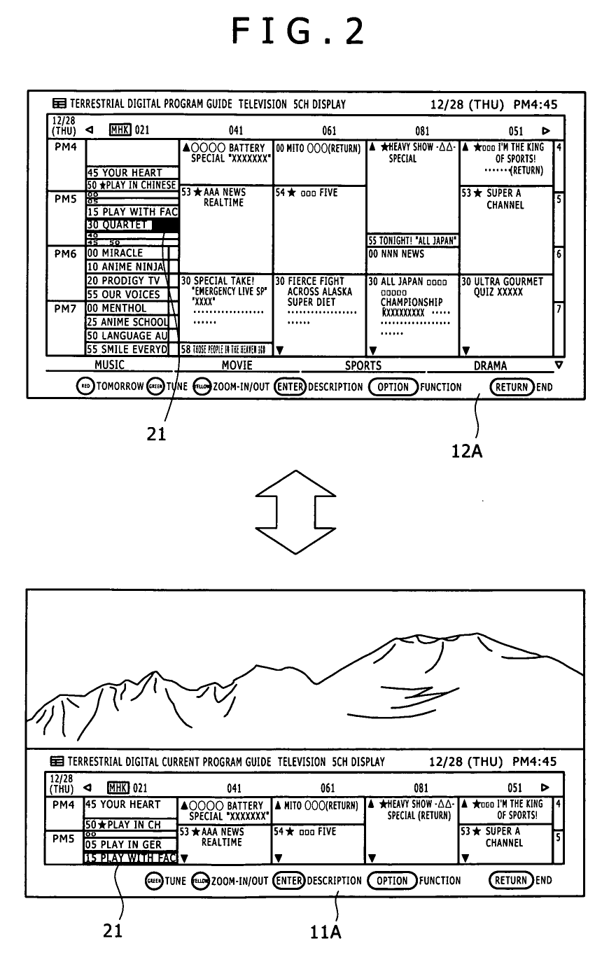

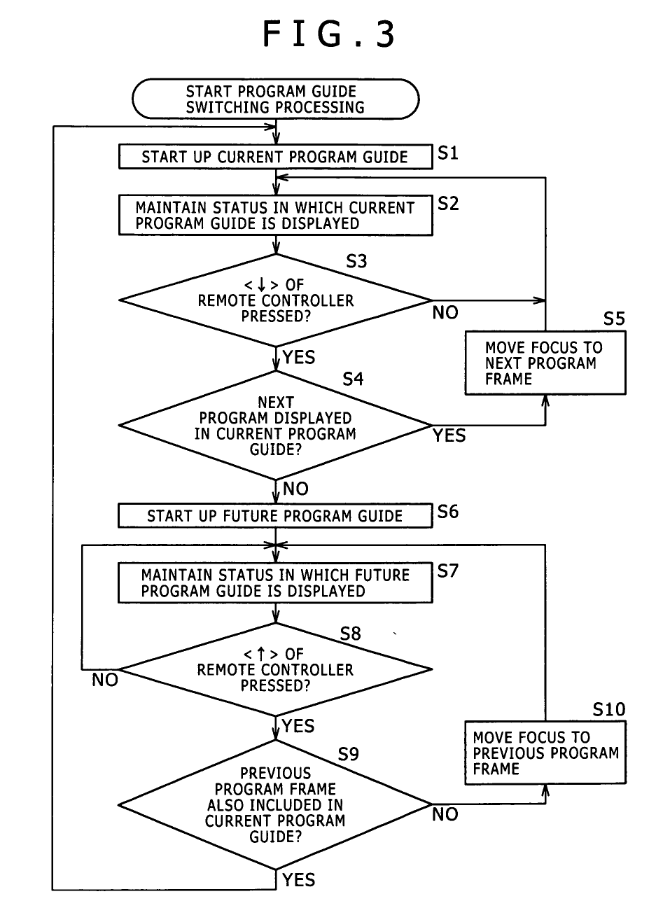

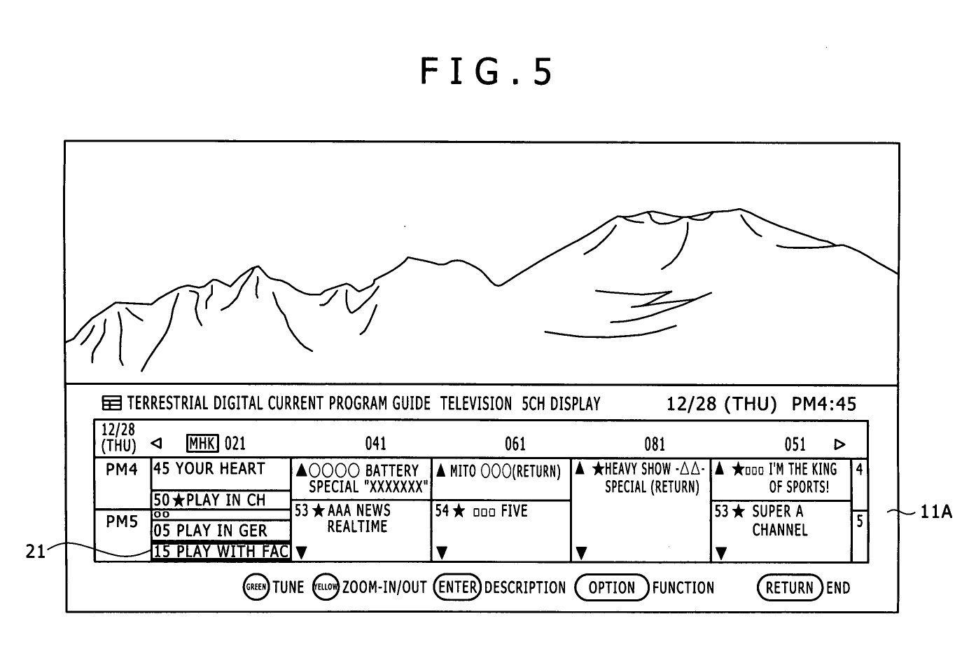

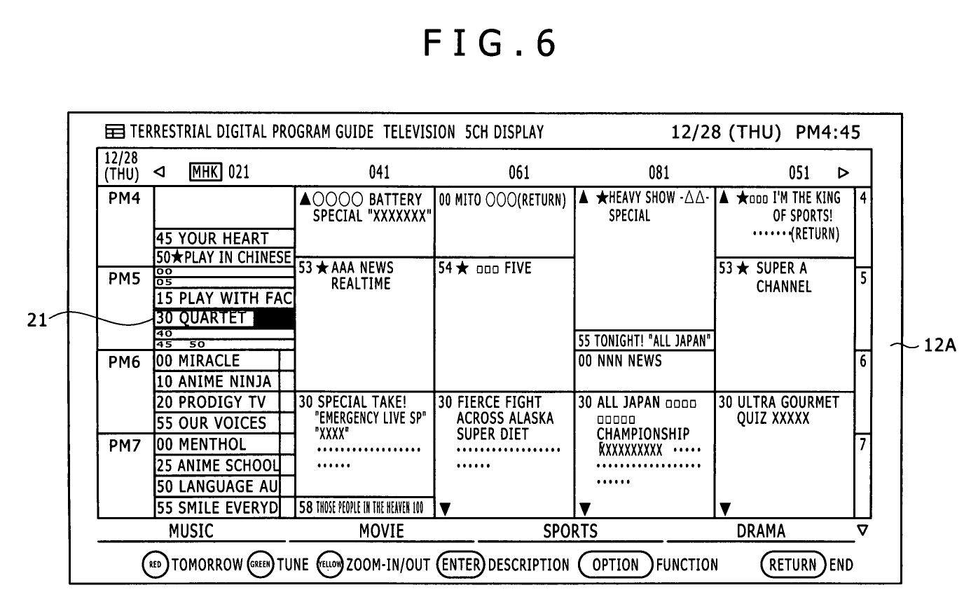

The above-mentioned information processing apparatus further has a operator unit (for example, a operator block 201 shown in FIG. 12) through which the user moves the focus content frame, wherein if the focus content frame has moved outside the first range (for example, it is determined to be NO in step S4 of FIG. 3; to be more specific, the focus 21 has moved further downward in a status shown in FIG. 5) by an operation by the user through the operator unit with the first content guide (for example, a current program guide 11A shown in FIG. 2, one example of the main content guide 11 shown in FIG. 1) presented, the presentation control unit determines that the first condition has been satisfied, thereby presenting, to the user, the second content guide (for example, a future program guide 12A shown in FIGS. 2 and 6, one example of the associated content guide 12 shown in FIG. 1) formed by the second range including at least the first range and, if the focus content frame has moved into the first range (for example, it is determined to be YES in step S9 of FIG. 3; to be more specific, the focus 21 has moved further upward in the status shown in FIG. 6) by an operation done by the user through the operator unit with the second content guide presented, the presentation control unit presents, to the user, the first content guide.

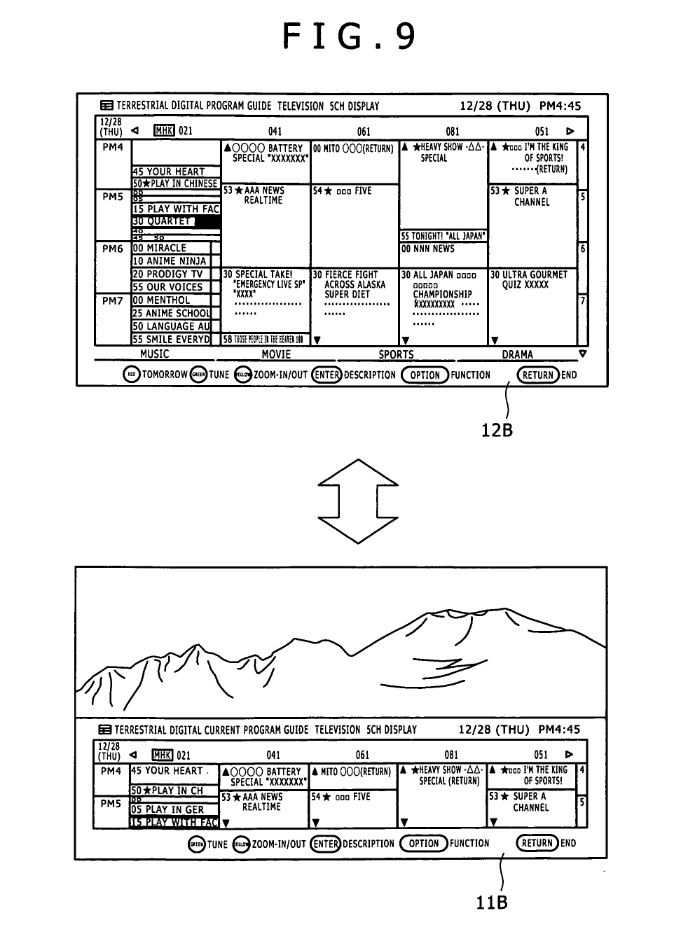

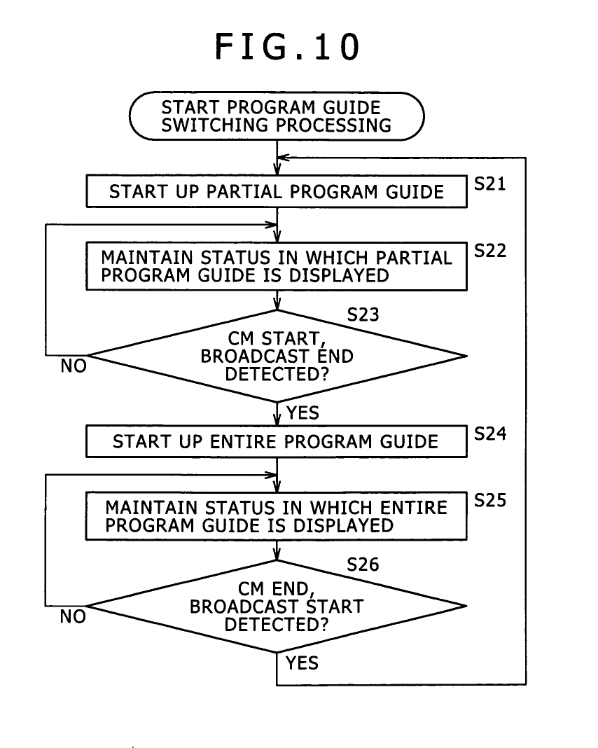

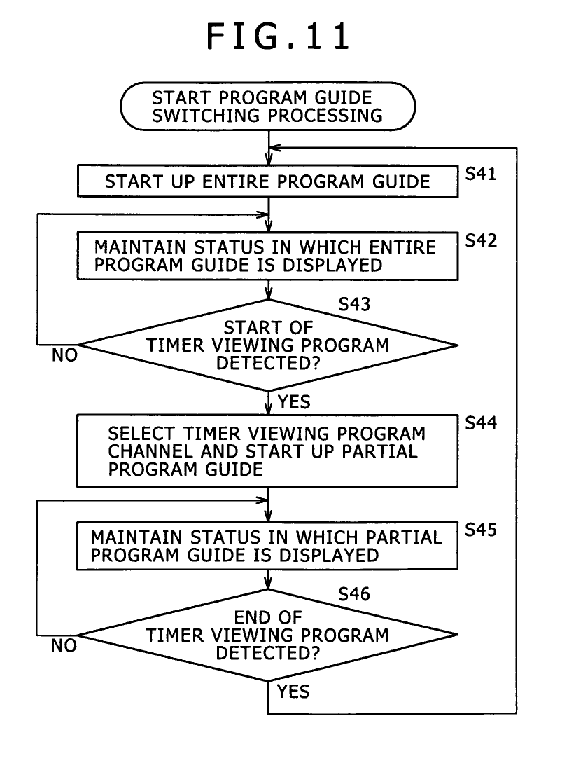

In the above-mentioned information processing apparatus, if the first content guide (for example, a partial program guide 11B shown in FIG. 9, one example of the main content guide 11 shown in FIG. 1) is presented, the presentation control unit presents, to the user, the second content guide when a status in which the user uses predetermined content is switched from a first status to a second status (for example, it is determined to be YES in step S23 shown in FIG. 10 or YES in step S46 shown in FIG. 11) and, if the second content guide is presented, the presentation control unit presents, to the user, the first content guide when the status in which the user uses predetermined content is switched from the second status to the first status (for example, it is determined to be YES in step S26 shown in FIG. 10 or YES in step S43 shown in FIG. 11).

The information processing method of one embodiment of the invention corresponds to the above-mentioned information processing apparatus of one embodiment of the invention and has program guide switching processing steps shown in FIGS. 3, 10, and 11, for example.

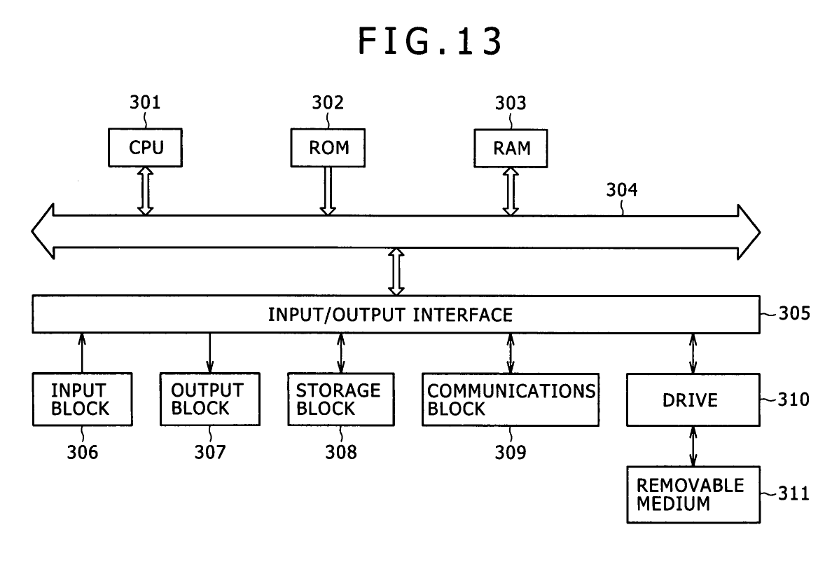

The computer program of one embodiment of the invention corresponds to the above-mentioned information processing method one of embodiment of the invention and can make the computer having a configuration shown in FIG. 13 for example execute the above-mentioned program guide switching processing.

Now, referring to FIG. 1, a technique to which the present invention is applied will be described.

The technique to which an embodiment of the present invention is applied is one of techniques configured to present a list of one or more items of content to users as a GUI (Graphical User Interface) image. Therefore, in what follows, the technique to which an embodiment of the present invention is applied will be referred to as a GUI display technique of the present invention.

It should be noted that term “content” as used herein widely denotes what is created by human creative activities and the present invention is applicable to such creations.

For example, these creations include movies, music, dramas, literature, photographs, manga, animation, computer games made up of characters, graphics, colors, voices, actions, or video or combinations thereof or programs for providing these pieces of information associated therewith by means of electronic computers, for example. The present invention is applicable to any thereof.

It should be noted, however, that, in order to ease the understanding of the present invention, it is assumed, in the first embodiment and the second embodiment, for example, that television broadcast programs be used as content.

A list of content is configured such that frames in which the information for guiding content is inserted are arranged. In what follows, such a content list will be referred to as a content guide and a frame thereof will be referred to as a content frame.

Herein, a content guide (hereafter referred to as a main content guide) configured by a first range including a reference content frame with a predetermined time of content as reference content, and other two or more content frames can be employed.

To be more specific, in the example shown in FIG. 1, a content guide 11 is the main content guide. In this example, each frame is indicative of a content frame, the content frame indicated by reference C provides a reference content frame.

The user can select a desired item of content by operating a predetermined operation device, such as a remote controller, for example. To be more specific, the selection of a desired item of content denotes the selection of the content frame of this desired item of content. In this case, from the viewpoint of the information processing apparatus, a content frame selected by the user is said to be a content frame that is in focus as a subject of processing. Therefore, such a content frame will be hereafter referred to as a focus content.

For instance, in the example shown in FIG. 1, a focus 21 is placed on the content frame in attention in the main content guide 11. Namely, in the example shown in FIG. 1, by moving the focus 21 through the operating device, the user can change focus content frames.

When a predetermined condition has been satisfied with the main content guide 11 displayed to the user, a content guide to be presented to the user changes to a content guide 12 (hereafter referred to as an associated content guide 12) shown in a lower section of FIG. 1.

In the example shown in FIG. 1, the associated content guide 12 is made up of a second range including the first range of the main content guide 11, namely, the second range larger than the first range.

It should be noted, however, that the second range of the associated content guide 12 is not limited to the example shown in FIG. 1; for example, the second range may only be any range that contains at least a focus content frame and is different from the first range of the main content guide 11.

As for the designation of the content guides as used herein, the associated content guide 12 seems to be subordinate to the main content guide 11; however, “associated” denotes nothing but convenient use for easy understanding of the embodiment of the present invention and therefore does not denote the subordination of the associated content guide 12 to the main content guide 11. Obviously, the associated content guide 12 can be made subordinate to the main content guide 11 by reason of design or the like.

Namely, in the present invention, a content guide composed of two or more ranges can be presented to the user; one of these ranges is referred to as the main content guide 11 and another as associated content guides 12 for convenience. In other words, the number of main content guide 11 and associated content guide 12 is not limited to one; for example, any number of main content guides 11 and associated content guides 12 may be two or more each as far as the ranges contained in each guide do not overlap. Two or more may include infinity, for example. If the infinite number of main content guides 11 or associated content guides 12 continue changing, it denotes that the display range of each content guide continuously increases or decreases on the screen.

A predetermined condition necessary for changing the main content guide 11 to the associated content guide 12 is not limited; for example, this condition may be set by designers in a desired manner.

For example, that a focus content frame has gotten outside the first range of the main content guide 11 may be used as the above-mentioned predetermined condition. To be more specific, as shown in FIG. 1, when the focus 21 scrolled downward has further moved down from a bottom content frame, then the predetermined condition is determined satisfied, thereby presenting the associated content guide 12. An embodiment of the present invention (hereafter referred to as a first embodiment) that is provided when the above-mentioned predetermined condition is employed will be described below with reference to FIGS. 2 through 8.

Also, the above-mentioned predetermined condition may be that a status in which the user is using (or viewing, for example) a particular item of content has been changed from a first status to a second status, for example. Namely, when the second status has been entered, the associated content guide 12 is presented. It should be noted that an embodiment of the present invention (thereafter referred to as a second embodiment) that is provided when the above-mentioned predetermined condition is satisfied will be described below with reference to FIGS. 9 through 11.

Conversely, the change from the associated content guide 12 to the main content guide 11 can be realized with ease and a predetermined conditions for such a change is not especially limited; therefore, this predetermined condition may be set by designers, for example, as desired.

As for the first embodiment, for example, that a focus content frame has gotten inside the first range of the main content guide 11 with a status in which the associated content guide 12 is presented to the user may be employed as a predetermined condition. To be more specific, as shown in FIG. 1, when the focus 21 being scrolled upward has moved to the gray range with the status in which the associated content guide 12 shown in a lower position in FIG. 1 is presented to the user, it is determined that the focus 21 has moved to the first range of the main content guide 11. Then, the predetermined condition is determined satisfied, thereby presenting the main content guide 11 again.

As for the second-embodiment, that a transition from the above-mentioned second status to the first status may be employed as a predetermined condition. Namely, when the first status has been entered, the main content guide 11 is presented again.

The following describes the first embodiment and the second embodiment that are examples of GUI display techniques according to the present invention with reference to accompanying drawings.

### The First Embodiment

With the first embodiment, it is assumed that a digital broadcast program (or a broadcast program or a program for short) be used as content for the convenience of description. So, in what follows, a content guide is appropriately referred to as a program guide and a content frame as a program frame. Unless otherwise noted, this program frame has time axis that is shown in the vertical direction and a broadcast station axis that is shown in the horizontal direction. In what follows, each broadcasting station is represented as a channel uniquely allocated thereto; namely, the horizontal axis is indicative of the channel axis.

As shown to the lower part of FIG. 2, a program currently being viewed by the user (in the example of FIG. 2, a program in which mountains are presented) provides the reference content (or the reference program). A program guide 11A (hereafter referred to as a current program guide 11A) made up of program frames for programs to be broadcast from a predetermined number of channels (five broadcasting stations in the example shown in FIG. 2) within a predetermined period of time (about two hours in the example shown in FIG. 2) starting from a current time (about p.m. 4:00 in the example shown in FIG. 2) is employed as a main content guide (or a main program guide).

To be more specific, the current program guide 11A denotes a program guide in which program frames of programs currently broadcast or to be scheduled for broadcast soon (about two hours later) are arranged in one part of a screen in viewing (the screen showing mountains in the example of FIG. 2).

A general purpose of use of the current program guide 11A includes the checking of the contents of each program currently broadcast or to be broadcast soon while viewing the program in viewing, for example.

As shown to the upper part of FIG. 2, a so-called weekly program guide 12A, namely, the weekly program guide 12A that includes program frames of more future than any program frames indicated by the current program guide 11A, is employed as an associated content guide (or an associated program guide). It should be noted that the weekly program guide 12A including future program frames as above is hereafter referred to as a future program guide 12A.

To be more specific, the future program guide 12A is a program guide in which the program frames of programs to be broadcast up to about one week from the currently broadcast program are arranged. However, only the program frame in the time zone in a range in accordance with a screen size is displayed, of all time zones (time zones of about one week) covered by the future program guide 12A.

A general purpose of use of the future program guide 12A includes the checking of future program broadcasting schedules and the timer viewing of future programs selected by the user, for example.

For an operation device for selecting and operating each focus program frame (or a focus content frame), a remote controller, not shown, arranged with at least direction keys, such as <↑>, <↓>, <←>, and <→>, is used.

Key <↑> is pressed to move the focus 21 upward.

Key <↓> is pressed to move the focus 21 downward.

Key <←> is pressed to move the focus 21 to the left.

Key <→> is pressed to move the focus 21 to the right.

Using the above-mentioned remote controller, the user can switch between the future program guide 12A and the current program guide 11A in an intuitive way.

To be more specific, pressing key <↓> of the remote controller with the current program guide 11A at the lower part of FIG. 2 displayed allows the user to sequentially move the focus 21 to the program frames of the programs immediately following the channel of the currently viewed program. Namely, the focus program frames sequentially move along with the downward movement of the focus 21.

Then, as shown to the lower part of FIG. 2, when the user presses key <↓> of the remote controller with the focus 21 positioned to the bottom program frame of the current program guide 11A, namely, the bottom program frame of the current program guide 11A selected as the focus program frame, the focus program frame (or the focus 21) is equivalent to the downward movement outside of the current program guide 11A, so that, in this case, the display screen is switched to the future program guide 12A shown to the upper part of FIG. 2.

Conversely, when the user presses key <↑> of the remote controller with the future program guide 12A to the upper part of FIG. 2 displayed, the focus 21 sequentially moves to upper program frames. Namely, the focus program frames sequentially move upward in accordance with the upward movement of the focus 21. Then, when the focus 21 has moved to a program frame (the same frame as the program frame at the bottom of the current program guide 11A to the lower part of FIG. 2) included also in the current program guide 11A of the future program guide 12A to the upper part of FIG. 2, the display screen is switched to the current program guide 11A as shown to the lower part of FIG. 2.

FIG. 3 shows a flowchart indicative of the processing (hereafter referred to a program guide switching processing) on the side of the information processing apparatus that is executed along with the above-mentioned user operation, for example. Namely, FIG. 3 shows the program guide switching processing to be executed by the information processing apparatus practiced as one embodiment of the invention.

In step S1, the information processing apparatus starts up the current program guide 11A.

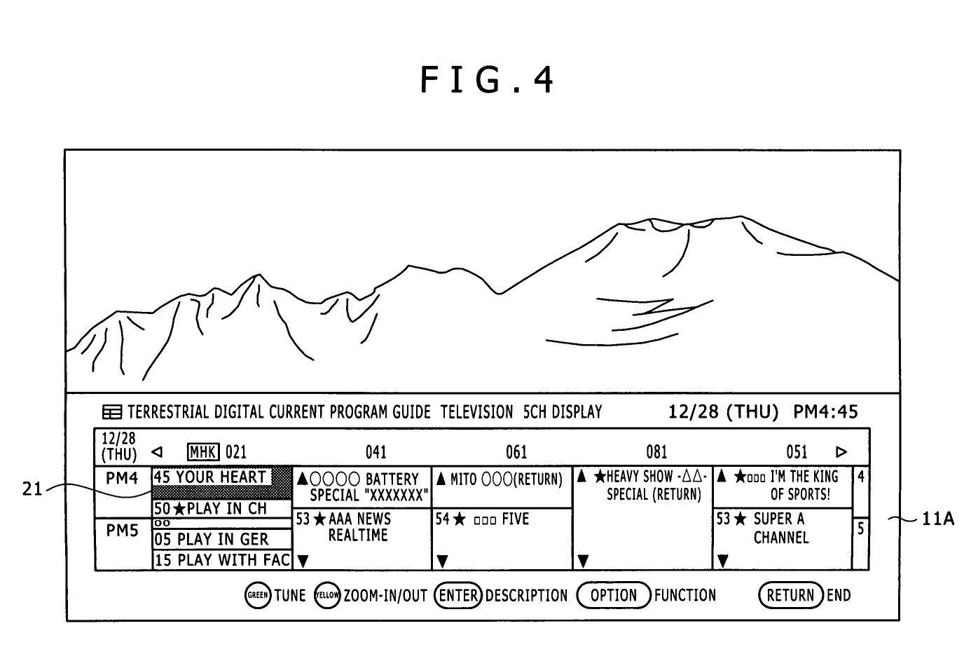

Starting up of the current program guide 11A denotes displaying of the current program guide 11A at least in a part of a display screen as shown in FIG. 4.

A method of starting up the current program guide 11A by the user is not especially restricted; for example, a predetermined key arranged on the remote controller may be pressed or a so-called “Enter” button displayed on a GUI screen may be pressed. The position of the focus 21 when the current program guide 11A has been started up by the user is the program frame of a currently viewed program (a program corresponding to a mountain picture displayed in the back), namely, the reference program frame as referred to herein. Namely, for an initial value of the focus program frame, the reference program frame is used.

To be more specific, in the example shown in FIG. 4, a program frame “45 Your Heart” is the reference program frame. The focus 21 is positioned to this program frame. Namely, when the current program guide 11A is first start up, the focus program frame is initialized. “First” denotes the difference from the starting up after the process of step S9 to be described later.

In step S2, the information processing apparatus maintains a status in which the current program guide 11A is displayed. It should be noted that, to be strict, the process of step S2 includes not only the maintenance of the display of the current program guide 11A itself, but, when a direction key other than key <↓> of the remote controller is pressed, the movement of the focus 21 in the direction of that pressed key.

In step S3, it is determined whether key <↓> of the remote controller has been pressed.

Until the user presses key <↓> of the remote controller, it is determined to be NO in step S3, upon which the procedure returns to step S2. Namely, until the user presses key <↓> of the remote controller, the information processing apparatus waits for that pressing operation.

When the user presses key <↓> of the remote controller, it is determined to be YES in step S3, upon which the procedure goes to step S4.

In step S4, the information processing apparatus determines whether a next program is displayed in the current program guide 11A.

As shown in FIG. 4, if another program frame is displayed below the program frame indicated by the focus 21, namely, the focus program frame, then it is determined in step S4 that a next program is further displayed in the current program guide 11A, upon which the procedure goes to step S5. In step S5, the information processing apparatus moves the focus 21 to a next program frame. For example, when the user presses key <↓> of the remote controller in the status shown in FIG. 4, the focus 21 moves to the program frame “50 ★Play in Chinese” as a result of the process of step S5, not shown. Namely, the focus program frame moves from the program frame “45 Your Heart” to the program frame therebelow.

Next, the procedure returns to step S2 to repeat the above-mentioned processing therefrom. Namely, every time key <↓> of the remote controller is pressed by the user, the focus 21 sequentially moves downward. In other words, the focus program frames move downward one by one.

Then, as shown in FIG. 5, the focus 21 is positioned at the bottom program frame in the current program guide 11A. Namely, the focus program frame moves to the program frame “15 Play with Faces” at the bottom of the current program guide 11A.

In the status shown in FIG. 5, no program frame is displayed below the program frame to which the focus 21 is positioned, namely, the focus program frame. In other words, when the focus program frame is moved downward, the moved focus program frame gets out of the range of the current program guide 11A. Therefore, when the user presses key <↓> of the remote controller, YES is determined in step S3 and then NO in step S4, namely, no next program is displayed in the current program guide 11A, upon which the procedure goes to step S6.

In step S6, the information processing apparatus starts up the future program guide 12A.

The starting up of the future program guide 12A denotes displaying of the future program guide 12A on the display screen as shown in FIG. 6.

It should be noted here that the focus 21 is positioned to a program frame next to the bottom program frame in the current program guide 11A (the program frame that has been outside the current program guide 11A). To be more specific, in the current program guide 11A shown in FIG. 5, the focus 21 is positioned to the program frame next to program frame “15 Play with Faces” that has been at the bottom, namely, the focus 21 is positioned at the program frame “30 Quartet” in the future program guide 12A shown in FIG. 6.

Namely, from the viewpoint of focus program frame, regardless whether the program guide displayed on the screen is the current program guide 11A or the future program guide 12A, the focus program frame moves downward in accordance with the pressing of key <↓> of the remote controller by the user.

In other words, the user can switch from the current program guide 11A to the future program guide 12A by an intuitive operation of pressing the key <↓> of the remote controller downward, namely, by moving downward the focus program frame (the focus 21).

In step S7, the information processing apparatus maintains a status in which the future program guide 12A is displayed.

However, to be exact, the process of step S7, as with the process of step S2, includes not only the maintenance of displaying of the future program guide 12A itself, but also, if a direction key other than key <↑> of the remote controller is pressed, the process of moving the focus 21 in the direction of the pressed key.

In step S8, it is determined whether key <↑> of the remote controller has been pressed.

Until the user presses key <↑> of the remote controller, it is determined to be NO in step S8, upon which the procedure returns to step S7. Namely, until the user presses key <↑> of the remote controller, the information processing apparatus waits for the pressing of this key by the user.

Next, when the user presses key <↑> of the remote controller, it is determined to be YES in step S8, upon which the procedure goes to step S9.

In step S9, the information processing apparatus determines whether the previous program frame is included also in the current program guide 11A.

It should be noted that the above-mentioned previous program frame denotes a focus program frame, namely, a program frame at which the focus 21 is positioned.

If the previous program frame is found not included in the current program guide 11A, then the determination is NO in step S9, upon which the procedure goes to step S10. In step S10, the information processing apparatus moves the focus 21 to the previous program frame. Then, the procedure returns to step S7 to repeat the above-mentioned processing therefrom.

In the status shown in FIG. 6, the focus 21 is positioned at program frame “30 Quartet”. Namely, the program frame “30 Quartet” is the focus program frame and the program frame before this program frame “30 Quartet” is program frame “15 Play with Faces” that is included in the current program guide 11A as shown in FIGS. 4 and 5.

Therefore, when the user presses key <↑> of the remote controller in the status shown in FIG. 6, it is determined to be YES in step S9, upon which the procedure returns to step S, thereby restarting the current program guide 11A.

It should be noted here that the focus 21 is positioned not at the reference program frame (refer to FIG. 4), but at the bottom program frame in the current program guide 11A, namely, the program frame “15 Play with Faces” as shown in FIG. 5.

Namely, from the viewpoint of the focus program frame, regardless whether the program guide displayed on the screen is current program guide 11A or the future program guide 12A, the focus program frame moves upward in accordance with the pressing of key <↑> of the remote controller by the user.

In other words, the user can switch from the future program guide 12A to the current program guide 11A by an intuitive operation of pressing the key <↑> of the remote controller downward, namely, by moving upward the focus program frame (the focus 21).

So far, the program guide switching processing practiced as the first embodiment of the invention has been described.

The above-mentioned first embodiment is configured to alternately switch between the current program guide 11A and the future program guide 12A depending on whether a focus content frame (or the focus 21) is included in the current program guide 11A. Therefore, the first embodiment is not limited to the example of program guide switching processing shown in FIG. 3 but may have variations.

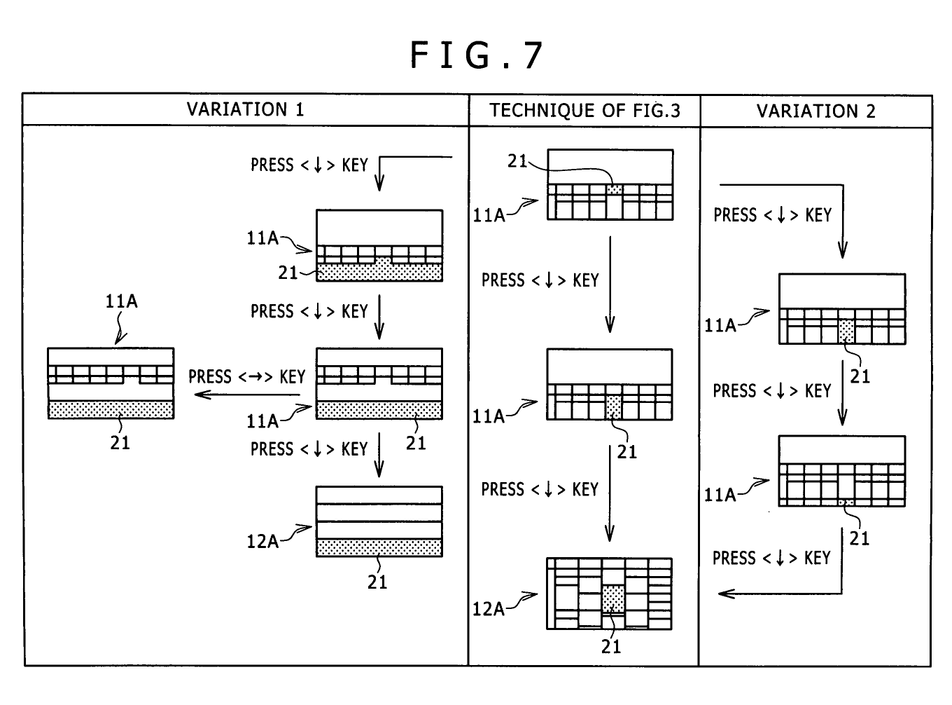

For example, even in using the pressing of keys <↑> and <↓> of remote controllers for an operating method, the switching from the current program guide 11A to the future program guide 12A need not use a method in accordance with the program guide switching processing shown in FIG. 3; namely, various other methods are available. For example, two different examples are shown in FIG. 7 for specific examples of these variations. It should be noted that, in FIG. 7, each gray portion is indicative of the focus 21.

The figure in the center of FIG. 7, namely, the figure in column “Technique of FIG. 3” illustrates the method according to the program guide switching processing shown in FIG. 3.

The figure to the left side of FIG. 7, namely, the figure in column “Variation 1” illustrates an exemplary technique different from the technique based on the program guide switching processing shown in FIG. 3.

In this example, when key <↓> of the remote controller is pressed, the focus program frame moves downward without displaying other channel program frame in that time zone, thereby displaying the focus program frame (the program frame at which the focus 21 is positioned) in the horizontal direction in a zoom-in manner. This results in an advantage of showing more detail information in the zoom-in focus program frame.

The figure to the right side of FIG. 7, namely, the figure in column “Variation 2” illustrates another exemplary technique different from the techniques based on the program guide switching processing shown in FIG. 3.

In this example, when key <↓> of the remote controller is pressed, the focus program frame moves downward; however, if the program frame to be moved as the focus program frame is not displayed in the current program guide 11A, then the current program guide 11A added with a time zone area of that program frame is first displayed, upon which the focus program frame moves downward. Namely, the current program guide 11A grows stepwise larger to be eventually switched to the associated content guide 12A that is displayed full screen.

Also, for example, a method may be used in which a key other than keys <↑> and <↓> of the remote controller is used for switching from the current program guide 11A to the future program guide 12A. To be more specific, a function may be allocated to key “Tomorrows”; that is, if key “Tomorrow” is arranged on the remote controller and this key “Tomorrow” is pressed by the user, it is determined that the user wants to check an entire program guide of tomorrow, namely, a command has been issued by the user so as to move the focus program frame (or the focus 21) to a tomorrow's program frame not existing in the current program guide 11A, thereby switching to the full-screen future program guide 12A including tomorrow's program guide, arranging a predetermined tomorrow's program focus 21. In other words, a function of moving the focus program frame to a tomorrow's predetermined program frame can also be allocated to key “Tomorrow”.

It should also be noted that the current program guide 11A and the future program guide 12A themselves are not especially limited to the examples shown in FIGS. 2 through 6.

Namely, the examples shown in FIGS. 2 through 6 are program guides each configured by a two-dimensional plane with the vertical axis allocated to time and the horizontal axis to channel. In this case, a program guide with the vertical axis allocated to channel and the horizontal axis allocated to time may also be employed for the current program guide 11A or the future program guide 12A. If such a program guide is used, the same techniques as those shown in FIGS. 2 through 6 can be realized by operating keys <←> and <→> of the remote controller instead of keys <t> and <↓> of the remote controller.

Further, various other axes may be used than those used in the current program guide 11A and the future program guide 12A.

For example, if the horizontal axis is allocated to channel, the sequence of channels is not limited to a particular sequence; for example, the channels may be arranged in an ascending or descending order, a channel being viewed may be arranged at the center among channels, or in the order of recommendation.

Also, for example, because the first embodiment is intended to switch between program guides having different ranges, the combinations of program guides for switching are not restricted to the combination of the current program guide 11A and the future program guide 12A.

Namely, the combination of the current program guide 11A and the future program guide 12A is used to allow the user to execute an intuitive operation from the viewpoint of time. It is also practicable to use following combinations for allow the user to execute an intuitive operation from the viewpoint of channel.

To be more specific, for example, two or more program guides having different number of display channels, using a channel axis for a predetermined axis, the channels being arranged along this axis in the order of recommendation, can be employed as the current program guide 11A. If key “Recommend” is arranged on the remote controller, for example, a function can be allocated to this key that, when this “Recommend” key is pressed by the user with a program guide including channel 1 to channel N (N being one or higher integer) in recommendation degree displayed, then it is determined that this key pressing is a command for the user to check a program of a channel having a recommendation degree of N+1, namely, a command for moving the focus content frame (or the focus 21) to a program frame of a channel of N+1 recommendation degree not existing in the currently displayed program guide, thereby switching to a program guide including channels 1 to N+1 in recommendation degree. That is, in this case, in accordance with the degree of recommendation, the program guide is displayed stepwise in a zoom-in manner.

Also, it is easily practicable to display a channel high in recommendation at the center of a program guide, thereby displaying the program guide in stepwise zoom-in manner toward the left and right ends from the center.

In the above-mentioned variations, each program guide is displayed as superimposed on a viewing screen (in the example shown in FIG. 4, the screen showing mountains, for example); it is not restricted to such an example. For example, it is also easily practicable to display the viewing screen in a reduced manner in accordance with the size of a program guide or display a program and the viewing screen side by side.

In the examples shown in FIGS. 3 through 6, when key <↓> of the remote controller is pressed with the focus 21 positioned to the bottom program frame in the current program guide 11A, switching is immediately made from the current program guide 11A to the associated content guide 12. Namely, in the examples shown in FIGS. 3 through 6, switching is immediately made to the future program guide 12A upon pressing of key <↓> of the remote controller even if the pressing has been made mistakenly by the user.

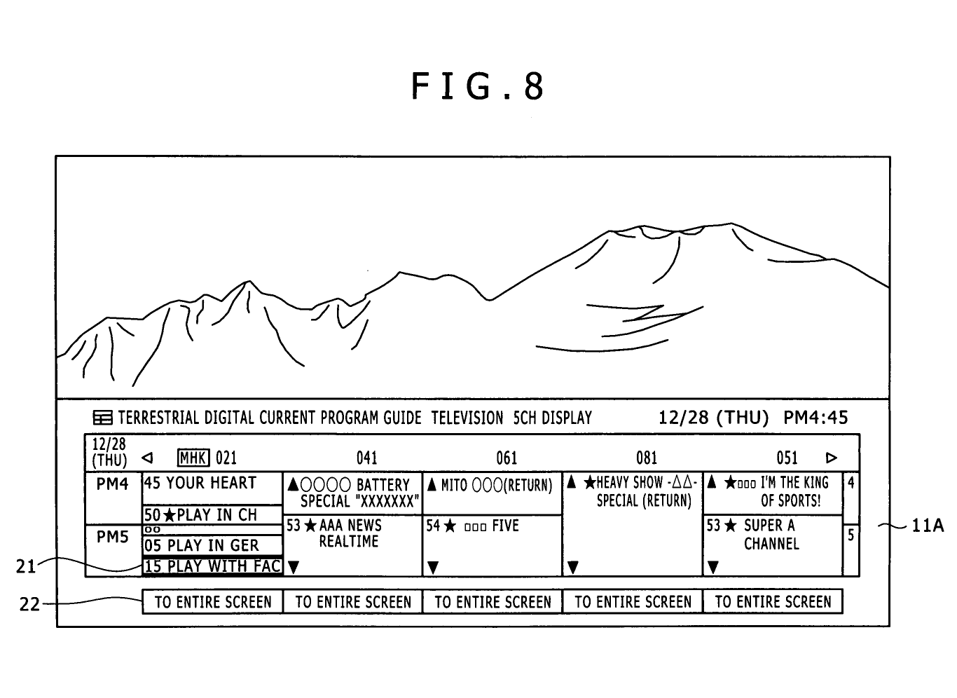

In order to prevent such a mistake operation from happening, a dummy frame 22 titled as “To Full Screen” may be arranged below the real program frame of each channel, thereby regarding this dummy frame 22 as the bottom program frame of the current program guide 11A. In this case, even if key <↓> of the remote controller is pressed with the focus 21 positioned to a real program frame originally at the bottom (in the example shown in FIG. 8, program frame “15 Play with Faces”, the focus 21 may only move the dummy frame 22, SO that switching will not be made immediately to the future program guide 12A.

Use of the above-described first embodiment brings about the following advantages.

Namely, in related-art technologies, a current program guide and a future program guide themselves are placed side by side. However, in related art, the user separately starts up a future program guide and a current program guide by pressing a dedicated key on the remote controller or an enter key displayed on GUI in accordance with the purpose of use of these program guides.

In this case, the user is required to execute a troublesome task to switch between the current program guide and the future program guide. For example, if, in checking a program in the current program guide on the time axis, the user wants to check a program to be broadcast next not displayed in the current program guide, the user needs to close the current program guide and start up the future program guide. Further, in the future program guide thus started up, the initial position of the focus is at a program frame in the upper left, namely, a program frame not associated with any program frame arranged in the current program guide, for example. Namely, the focus program frame is processed independently between the current program guide and the future program guide. As a result, after the future program guide has been started up, the user needs to execute a troublesome task of repeating the operation of moving the focus to reach a desired program (namely, make the program frame of a desired program the focus program frame), for example.

In contrast, in the first embodiment, the user may only execute intuitive operations of pressing keys <↑> and <↓> of the remote controller as described above to switch between the future program guide 12A and the current program guide 11A. Further, because the focus program frames (on which the focus 21 is positioned) before and after switching are mutually associated program frames, the total number of steps for reaching a desired program (the program frame of a desired program is the focus program frame) is smaller than that of related-art technologies. This provides an advantage that the user can reach a desired program more easily and quickly than the related-art technologies. It should be noted that mutually associated programs denote those programs continuously broadcast on a same channel or those programs of different channels being broadcast in a same time zone.

To be more specific, the examples shown in FIGS. 2 through 6 provide an advantage that the user can switch to a more proper screen (or a future program guide) while checking programs along the time axis, for example.

Use of variations shown in FIG. 7 or techniques of program guide switching from the viewpoint of channel as described above allows the user to check the necessary detail information about programs, the information for the number of necessary channels, and so on, for example.

Use of a program guide having a configuration based on the degree of recommendation (or preference) as described above allows the user to check programs from the descending order of preference, for example.

Use of the technique as shown in FIG. 8, namely, the technique of preventing user's mistake switching operation (or an error operation) allows the user to switch between screens at ease.

### The Second Embodiment

The following describes the second embodiment of the invention.

The second embodiment denotes one embodiment of the invention that, as described above, with the main content guide being presented to the user, if the status in which the user uses (or views) content changes from a first status to a second status, the presentation is switched from the main content guide to an associated content guide and, if the status changes from the second status to the first status, the presentation is switched from the associated content guide to the main content guide.

It should be noted, however, that, with the second embodiment, a digital broadcast program (hereafter also referred to simply as a program) is used as content so as to ease the description as with the first embodiment.

As shown to the lower part in FIG. 9, a program guide 11B displayed in a part of display screen (hereafter referred to as a partial program guide 11B) is used as a main content guide (or a main program guide). In addition, as shown to the upper part in FIG. 9, a program guide 12B displayed full screen (hereafter referred to as an entire program guide 12B) is used as an associated content guide (or an associated program guide).

It should be noted that, in the example shown in FIG. 9, the above-mentioned current program guide 11A shown in FIG. 2 is used as the partial program guide 11B without change. However, the partial program guide 11B is not limited to the example shown in FIG. 9; any program guide that is displayed in a part of display screen can be used as defined above. For example, another program guide that is started up by the user for checking during viewing, a counter-program guide, to be specific, can be used as the partial program guide 11B.

Likewise, in the example shown in FIG. 9, the above-mentioned future program guide 12A shown in FIG. 2 is used as the entire program guide 12B without change. However, the entire program guide 12B is not limited to the example shown in FIG. 9; any program guide that is displayed full screen can be used as defined above.

Further, various statuses can be used as “a status in which the user is using (or viewing) content”, namely, “a status in which the user is viewing a program” here.

For example, for “a status in which the user is viewing a program”, the display status of that screen can be used. Namely, for a first status, a status in which a program main section is displayed can be used; for a second status, a status in which others are displayed, CM (Commercial Message) in a main section is displayed, for example, or a program has ended can be used.

In this case, while the user is viewing a program main section, the partial program guide 11B is displayed along with this main section and, when a CM starts or the program has ended, the entire program guide 12B is displayed.

One example of program guide switching processing to be executed in the above-mentioned case is shown in a flowchart shown in FIG. 10. Namely, FIG. 10 shows one example of the program guide switching processing to be executed by the information processing apparatus to which the embodiment of the present invention is applied; therefore this program guide switching processing is different from that shown in FIG. 3.

It should be noted that, in the processing example shown in FIG. 10, if the information processing apparatus starts up the entire program guide 12B and the partial program guide 11B, this startup may be executed autonomously by the information processing apparatus (or automatically) or triggered by a command issued by the user through the remote controller, for example.

In step S21, the information processing apparatus starts up the partial program guide 11B.

In step S22, the information processing apparatus maintains a status in which the partial program guide 11B is displayed.

In step S23, the information processing apparatus determines whether a CM start or a broadcasting end has been detected.

It should be noted that a method of detecting a CM start or a broadcasting end (hereafter simply referred to as a CM detection technique) may be a known technique or a new technique to be realized in the future. In other words, a CM detection technique itself is not an essential part of the present invention. Therefore, only one available known technique will be introduced here.

To be more specific, programs and CMs involve not only video but also voice, in general. A voice signal has several audio modes. The audio mode of CMs is often a stereo mode, while the audio mode of programs is often a monaural mode or an audio duplex mode. Therefore, the information processing apparatus recognizes an audio mode switching timing to detect timings of CM start and so on. This CM detection technique is disclosed in Japanese Patent No. 2858758, for example.

If the information processing apparatus does not detect a CM start or a broadcasting end, namely, when a program main section is being broadcast, it is determined to be NO in step S23, upon which the procedure returns to step S22 to repeat loop processing of steps S22 and S23.

When the information processing apparatus detects a CM start or a broadcasting end, then it is determined to be YES in step S23, upon which the procedure goes to step S24 to start up the entire program guide 12B.

In step S25, the information processing apparatus maintains a status in which the entire program guide 12B is displayed.

In step S26, the information processing apparatus determines whether a CM end or a broadcasting start has been detected.

If the information processing apparatus does not detect a CM end or a broadcasting start, then it is determined to be NO in step S26, upon which the procedure returns to step S25 to repeat loop processing of steps S25 and S26.

Then, when the information processing apparatus detects a CM end or a broadcasting start, then it is determined to be YES in step S26, upon which the procedure returns to step S21 to restart the partial program guide 11B.

Thus, an example in which the display status (or broadcasting status) of that screen is used as “a status in which the user is viewing a program” has been described.

Alternatively, a program operation and setting status can be used as “a status in which the user is viewing a program”, for example.

To be more specific, a status in which the user views a program timer-started by the user is used as the above-mentioned first status and a status in which a timer-started program is not broadcast is used as the above-mentioned second status.

In this case, from the viewpoint of the timing before the start of timer-started program, the second status is on before the start of the timer-started program, so that the partial program guide 11B is displayed. When the timer-started program starts, the first status is entered, so that the entire program guide 12B is displayed.

One example of the program guide switching processing of the above-mentioned case is indicated by a flowchart shown in FIG. 11. Namely, FIG. 11 illustrates one example of the program guide switching processing to be executed by the information processing apparatus to which an embodiment of the present invention is applied and therefore this example is different from the examples shown in FIGS. 3 and 10.

It should be noted that, in the processing example shown in FIG. 11, if the information processing apparatus starts up the entire program guide 12B or the partial program guide 11B, this startup may be executed autonomously by the information processing apparatus (or automatically) or triggered by a command issued by the user through the remote controller, for example.

In step S41, the information processing apparatus starts up the entire program guide 12B.

In step S42, the information processing apparatus maintains a status in which the entire program guide 12B is displayed.

In step S43, the information processing apparatus determines whether the start of timer-started program has been detected or not.

Until the broadcasting of the timer-started program starts, it is determined to be NO in step S43, upon which the procedure returns to step S42 to repeat loop processing of steps S42 and S43.

Then, when the information processing apparatus detects the start of the timer-started program, it is determined to be YES in step S43 and the procedure goes to step S44, in which the channel of the timer-started program is selected to start the partial program guide 11B.

In step S45, the information processing apparatus maintains a status in which the partial program guide 11B is displayed.

In step S46, the information processing apparatus determines whether the end of the timer-started program has been detected or not.

During the timer-started program is broadcast, it is determined to be NO in step S46, upon which the procedure returns to step S45 to repeat loop processing of steps S45 and S46.

When the information processing apparatus detects the end of the timer-started program, it is determined to be YES in step S46, upon which the procedure returns to step S41 to restart the entire program guide 12B.

Thus, an example has been described in which a program operation and setting status is used as “a status in which the user is viewing a program”.

Alternatively, a user status can be used as “a status in which the user is viewing a program”, for example.

For example, if a user intention can be detected, the first status and the second status can be defined on the basis of that intention. To be more specific, for example, if a status in which the user is unsure which station to select is used as the first status and a status in which the user is not unsure is used as the second status, then, the information processing apparatus determines that the user is unsure which station to select if, when the entire program guide 12B is displayed, the user has executed selection-associated operations, such as operating the channel number key and channel ± key of the remote controller, three or more times within ten seconds, namely, the information processing apparatus determines that the first status has been entered, thereby autonomously (or automatically) switching to the partial program guide 11B.

Use of the above-described second embodiment provides the following advantages.

As described before for the advantages of the first embodiment, a current program guide and a future program guide are arranged side by side in related art. As described before, the user is required to start up the two program guides independently by separately executing a key pressing operation on the remote controller and on the GUI screen in accordance with the purpose of these program guides.

In this case, it is troublesome for the user to execute switching between the current program guide and the future program guide as described before.

In contrast, the second embodiment allows the information processing apparatus to properly switch between the entire program guide 12B (the future program guide 12A for example) and the partial program guide 11B (the current program guide 11A for example) in accordance with situations in an autonomous manner (namely, automatically). Therefore, the total number of steps for the user to reach a desired program (the program frame of the desired program is the focus program frame) becomes smaller than that of related-art techniques. Consequently, the user can reach a desired program more quickly and easily.

Namely, because the size of each program guide to be displayed is automatically switched to the size of a screen determined suitable for a situation at that time, user's operation load can be significantly mitigated.

Especially, use of the examples shown in FIG. 10 and so on, namely, switching between program guides in accordance with the display status (or broadcasting status) of screen allows the user to easily check program information full screen without the need for concentrating on the broadcast during a CM or before and after a program.

Further, use of the examples shown in FIG. 11 and so on, namely, switching between program guides in accordance with a program operation and setting status allows the user to check the minimum necessary program information (or the partial program guide 11B) while viewing a program when the user wants to view that program.

In addition, the second embodiment allows the user to help the user select a station by switching between the program guides when the user is unsure which station to select.

Thus, the GUI display techniques have been described as practiced as the first and second embodiments of the invention.

FIG. 12 shows a functional configuration example of an information processing apparatus to which the GUI display technique according to an embodiment of the invention is applied.

An information processing apparatus 101 is configured to include functional blocks, an operator block 201 through a display block 210.

The operator block 201, operated by the user, provides signals corresponding to operations done by the user to an input control block 202. In the above-described first and second embodiments, the remote controller on which directions keys, such as <↑> and <↓>, and other keys are arranged functions as the input control block 202.

The input control block 202 recognizes the operation done by the user on the basis of a signal supplied from the operator block 201 and transmits a result of the recognition to a screen information control block 207.

In the example shown in FIG. 12, in order to easily realize the above-described first and second embodiments, the information processing apparatus 101 uses digital broadcast programs as content that can be processed and uses program information obtained from EIT (Event Information Table) to generate various content lists (a main program guide and an associated program guide). These programs and EIT are transmitted from each broadcasting station in the form of transport streams specified by MPEG (Moving Picture Experts Group), for example. It should be noted that, in what follows, a transport stream will be referred to as a TS. Hence, the information processing apparatus 101 shown in FIG. 12 has a digital broadcast reception block 203 for receiving this TS and a digital broadcast reception processing block 204 for extracting a program and an EIT from the received TS and executing necessary processing on the extracted program and EIT as required.

In other words, if the content to be used by the user and the information necessary for generating various content guides (a main content guide and associated content guide) (hereafter generically referred to as content, etc.) are transmitted in other transmission forms than mentioned above, a reception block and a reception processing block suitable for such a transmission form are required. To be more specific, although not shown, if the content, etc. are transmitted over a predetermined network, such as the Internet, a reception block and a reception processing block that have capabilities of connecting with that network for communications processing are required.

A content information processing block 205 stores the content, etc. supplied from the digital broadcast reception processing block 204 into a storage block 206. In the example shown in FIG. 12, a digital broadcast program and an EIT supplied from the digital broadcast reception processing block 204 is stored in the storage block 206.

Also, the content information processing block 205 executes control of reading and updating information from the storage block 206 and, as required, providing the read information to a screen information control block 207.

In what follows, various kinds of information to be provided from the content information processing block 205 to the screen information control block 207 are generically referred to as content information. Namely, for example, this content information includes various kinds of information extracted from the EIT of each item of content; to be more specific, the information necessary for creating genre, broadcasting date, broadcasting station information, and titles.

The screen information control block 207 generates a content guide in the form of image data on the basis of the content information supplied from the content information processing block 205 and the user specification information supplied from the input control block 202 as required, thereby supplying the generated content guide to a display control block 209. At this moment, the screen information control block 207 executes control so as to always hold, in a screen information storage block 208, the screen information about the content guide currently subject to display.

The display control block 209 converts the content guide supplied from the screen information control block 207 in the form of image data into a signal suitable for the display block 210, displaying the content guide onto the display block 210. Namely, the display block 210 displays above-described various content guides, to be more specific, the current program guide 11A shown in FIG. 2, the future program guide 12A shown in FIG. 2, the partial program guide 11B shown in FIG. 9, and the entire program guide 12B shown in FIG. 9, for example.

It should be noted that the above-mentioned sequence of processing operations may be executed by software as well as hardware.

When the above-mentioned sequence of processing operations is executed by software, the information processing apparatus according to the invention can be configured by a computer shown in FIG. 13, for example.

Referring to FIG. 13, a CPU (Central Processing Unit) 301 executes various kinds of processing as instructed by programs recorded in a ROM (Read Only Memory) 302 or loaded from a storage block 308 into a RAM (Random Access Memory) 303. The RAM 303 also stores data, from time to time, that are necessary for the CPU 301 to execute various kinds of processing.

The CPU 301, the ROM 302, and the RAM 303 are interconnected through a bus 304. The bus 304 is connected with an input/output interface 305.

The input/output interface 305 is also connected with an input block 306 made up of a keyboard and a mouse, for example, an output block 307 made up of a display monitor, for example, a storage block 308 made up of a hard disk drive, for example, and a communications block 309 made up of a modem and a terminal adaptor, for example. The communications block 309 controls communication with outside devices through a network, such as the Internet, not shown.

The input/output interface 305 is also connected with a drive 310 as required, on which a removable medium 311, such as a magnetic disk, an optical disk, a magneto-optical disk, or a semiconductor memory, is loaded as required. Computer programs read from the removable disk are installed in the storage block 308 as required.

When the above-mentioned sequence of processing operations is executed by software, the programs constituting the software are installed in a computer which is built in dedicated hardware equipment or installed, from a network or recording media, into a general-purpose personal computer for example in which various programs may be installed for the execution of various functions.

As shown in FIG. 13, these recording media are constituted by not only a removable medium (or a package medium) 311 made up of the magnetic disk (including floppy disks), the optical disk (including CD-ROM (Compact Disk Read Only Memory) and DVD (Digital Versatile Disk)), the magneto-optical disk (including MD (Mini Disk) (trademark)), or the semiconductor memory which is distributed separately from the apparatus itself, but also the ROM 302 or the storage block 308 which stores programs and is provided to users as incorporated in the apparatus itself.

It should be noted herein that the steps for describing each program recorded in recording media include not only the processing operations which are sequentially executed in a time-dependent manner but also the processing operations which are executed concurrently or discretely.

It should also be noted that term “system” as used herein denotes a logical set of a plurality of component units and these component units are not necessary accommodated in a same housing.

While preferred embodiments of the present invention have been described using specific terms, such description is for illustrative purpose only, and it is to be understood that changes and variations may be made without departing from the spirit or scope of the following claims.

What is claimed is:

1. An information processing apparatus configured to present, to a user, a content guide arranged with a plurality of content frames including information for guiding predetermined content, said information processing apparatus comprising:
a presentation control unit configured to present, to said user, if a first content guide of a first range is being presented, a second content guide formed by a second range different from said first range when a first condition is satisfied, said second content guide including a focus content frame focused as processing subject when said first condition was satisfied, instead of said first content guide.

2. The information processing apparatus according to claim 1, wherein, if said second content guide is being presented, said presentation control unit presents said first content guide instead of said second content guide if a second condition is satisfied.

3. The information processing apparatus according to claim 2, further comprising:
an operator unit through which said user moves said focus content frame,
wherein, if said focus content frame has moved outside said first range by an operation by said user through said operator unit with said first content guide presented, said presentation control unit determines that said first condition has been satisfied, thereby presenting, to said user, said second content guide formed by said second range including at least said first range and,
if said focus content frame has moved into said first range by an operation done by said user through said operator unit with said second content guide presented, said presentation control unit presents, to said user, said first content guide.

4. The information processing apparatus according to claim 2, wherein, if said first content guide is presented, said presentation control unit presents, to said user, said second content guide when a status in which said user uses predetermined content is switched from a first status to a second status and,
if said second content guide is presented, said presentation control unit presents, to said user, said first content guide when the status in which said user uses predetermined content is switched from said second status to said first status.

5. An information processing method for an information processing apparatus configured to present, to a user, a content guide arranged with a plurality of content frames including information for guiding predetermined content, said information processing method comprising the steps of:
presenting, to said user, if a first content guide of a first range is being presented, a second content guide formed by a second range different from said first range when a first condition is satisfied, said second content guide including a focus content frame focused as processing subject when said first condition was satisfied, instead of said first content guide.

6. A program configured to present, to a user, a content guide arranged with a plurality of content frames including information for guiding predetermined content, said program comprising the steps of:
presenting, to said user, if a first content guide of a first range is being presented, a second content guide formed by a second range different from said first range when a first condition is satisfied, said second content guide including a focus content frame focused as processing subject when said first condition was satisfied, instead of said first content guide.

7. An information processing apparatus configured to present, to a user, a content guide arranged with a plurality of content frames including information for guiding predetermined content, said information processing apparatus comprising:
presentation control means for presenting, to said user, if a first content guide of a first range is being presented, a second content guide formed by a second range different from said first range when a first condition is satisfied, said second content guide including a focus content frame focused as processing subject when said first condition was satisfied, instead of said first content guide.
